(19) United States
(12) Patent Application Publication
(10) Pub. No.: US 2021/0124615 A1
(43) Pub. Date: Apr. 29, 2021

(54) THREAD SCHEDULING BASED ON PERFORMANCE METRIC INFORMATION

(71) Applicants: THOMAS KLINGENBRUNN, San Diego, CA (US); RUSSELL FENGER, Beaverton, OR (US); YANRU LI, San Diego, CA (US); ALI TAHA, San Diego, CA (US); FAROCK ZAND, Garden Grove, CA (US)

(72) Inventors: THOMAS KLINGENBRUNN, San Diego, CA (US); RUSSELL FENGER, Beaverton, OR (US); YANRU LI, San Diego, CA (US); ALI TAHA, San Diego, CA (US); FAROCK ZAND, Garden Grove, CA (US)

(21) Appl. No.: 17/083,394

(22) Filed: Oct. 29, 2020

Related U.S. Application Data
(60) Provisional application No. 62/927,161, filed on Oct. 29, 2019.

(51) Int. Cl. G06F 9/50; G06F 9/30

(52) U.S. Cl. CPC G06F 9/505; G06F 9/3004

(57) ABSTRACT

In one embodiment, a method includes: receiving, in a monitor, performance metric information from performance monitors of a processor including at least a first core type and a second core type; storing, by the monitor, an application identifier associated with an application in execution and the performance metric information for the first core type and the second core type, in a table; accessing, by a scheduler, at least one entry of the table associated with a first application identifier, to obtain the performance metric information for the first core type and the second core type; and scheduling, by the scheduler, one or more threads of a first application associated with the first application identifier to one or more of the plurality of cores based at least in part on the performance metric information of the at least one entry. Other embodiments are described and claimed.

This application claims priority to U.S. Provisional Patent Application No. 62/927,161, filed on Oct. 29, 2019, in the names of Thomas Klingenbrunn, Russell Fenger, Yanru Li, Ali Taha, and Farock Zand, entitled “System, Apparatus And Method For Thread-Specific Hetero-Core Scheduling Based On Run-Time Learning Algorithm,” the disclosure of which is hereby incorporated by reference.

### BACKGROUND

In a processor having a heterogeneous core architecture (multiple cores of different types), an operating system (OS) schedules tasks/workloads across the multiple core types. It is difficult for the OS to schedule a specific task/workload on the most suitable core, without any prior knowledge about the workload. For example, a certain workload may take advantage of hardware accelerators only available on certain cores, which is unknown to the scheduler. Or the workload may run more efficiently on a certain core type due to more favorable memory/cache architecture of that core, which again is not known to the scheduler.

### BRIEF DESCRIPTION OF THE DRAWINGS

FIG. 1 is a block diagram of an example system, in accordance with one or more embodiments of the present invention.

FIG. 2 is an illustration of an example data collection operation, in accordance with one or more embodiments of the present invention.

FIG. 3 is an illustration of an example look-up table, in accordance with one or more embodiments of the present invention.

FIG. 4 is a diagram of an example machine-readable medium storing instructions in accordance with some embodiments.

FIG. 5 is an illustration of an example process, in accordance with some with embodiments.

FIG. 6 is a schematic diagram of an example computing device, in accordance with some embodiments.

### DETAILED DESCRIPTION

In various embodiments, a scheduler may be configured to schedule workloads to particular cores of a multicore processor based at least in part on runtime learning of workload characteristics to schedule tasks such as threads to a most appropriate core or other processing engine. To this end, the scheduler may control data collection of hardware performance information across all cores at run-time. A new task may be scheduled on all core types periodically for the sole purpose of data collection, to ensure fresh up-to-date data per core type is continuously made available and adjusted for varying conditions over time.

Although the scope of the present invention is not limited in this regard, in one embodiment the scheduler may obtain data in the form of various hardware performance metrics. These metrics may include instructions per cycle (IPC) and memory bandwidth (BW), among others. In addition, based at least in part on this information, the scheduler may determine IPC loss (e.g., in terms of cycles) between 1) pipeline interlocks vs 2) L2 cache bound vs 3) memory bound for further granularity, helping in the scheduling decision.

Thus with embodiments, a scheduler may take advantage of core specific accelerators in the scheduling, in contrast to naïve scheduling which seeks to balance processing load across processors. And with embodiments, certain applications can be scheduled to particular cores to run more efficiently, either from a power or performance perspective.

In embodiments, data feedback may be continuously collected for all cores based on actual conditions, and thus IPC (e.g.,) can be self-corrected continuously. The amount of overhead added can be kept negligible by limiting the rate at which the data gathering across all cores is done (e.g., once per hour/day/ . . . ).

In some embodiments, IPC loss cycles can be used to help further improve scheduling decisions. For example, one core A with better IPC may start having a high congestion on L2 memory due to many threads running. In this case, it may be better to schedule some of the L2 intensive tasks on another core B even if it has lower IPC, because it would reduce the IPC for other tasks on core A, translating into overall better system performance.

In an embodiment, a task statistics collection entity may continuously gather data metrics, for example “instructions per cycle (IPC)”, per application running on the system. Such data metrics may describe how efficiently a task is running on a specific core type. A unique application ID may be associated with a given application to identify its metrics. This data can be accessed by the scheduler, which then tries to schedule tasks on the most efficient core type (e.g., highest IPC).

Take for example a workload that uses hardware accelerators (for example AVX in an Intel® architecture, or Neon in ARM architecture) only available on certain cores. The gathered IPC statistics for such a workload would be significantly higher on a core with the hardware accelerator. Hence the scheduler could take advantage of this information to ensure that the workload always runs on that core. Other statistics such as memory bandwidth could be used to determine which workloads can take advantage of cores with better cache performance.

The data gathering mechanism may work with the scheduler to ensure that initially a new task is scheduled “randomly” on different cores or hardware threads over time, to make sure IPC data is collected for all cores or hardware threads. Once IPC hardware measurements are available for all available cores and hardware threads, the OS scheduler will correctly schedule an application on the most preferred core or hardware thread (with highest IPC). Occasionally, the scheduler could schedule a task on non-preferred cores or hardware threads to collect a fresh IPC measurement, to account for IPC variations over time.

In embodiments, stall cycles may be broken down into: 1) Core stall cycles for inter-locks; 2) Core stall cycles due to L2 cache bound; and 3) Core stall cycles due to LLC/memory bound. This can further help in a scheduling decision, to decide to schedule a task which is L2 intensive on a core where L2 load is small (load balance L2 load).

As discussed, certain applications may run more efficiently on certain cores in a heterogeneous core architecture. By incorporating application awareness (by means of per-application statistics collection) into the scheduler, any application may be scheduled to run on the most efficient core, which improves performance and power efficiency, benefiting better user experience and longer battery life. In addition, run-time learning and continuous adaptation of the optimum scheduling thresholds provides advantages over using static scheduling thresholds determined in costly pre-silicon characterizations (needs to be done every time for new core microarchitecture changes). Furthermore, embodiments may be more flexible to adapt over time and to new applications (self-calibrating).

Embodiments may provide access to performance counters inside the core to extract thread specific information such as cycle count, instruction count etc., with a low time resolution (e.g., millisecond or less). In this way, detailed thread specific instructions-per-cycle (IPC) statistics may be obtained to help the scheduler decide which core to run a specific task.

With embodiments, two unknown applications (i.e. not previously run on a system) with different IPC or memory BW requirements may be executed, and after data collection, scheduling in accordance with an embodiment may be performed to realize a behavioral change in scheduling over time as the system learns about the differences between the apps.

Assume a heterogeneous core system with certain large cores supporting special hardware accelerated (e.g., AVX) instructions, and small cores that do not have it. Assume a first application (App A) extensively uses these special instructions, the IPC on the big core would be much higher than on the little core. An application (App B) without the special instructions would have a more comparable IPC on the two core types.

Beginning execution without a priori information for these two applications, data may be collected on the cores on which the two applications are scheduled, by monitoring the task manager or by hardware counter profiling. Initially, the scheduler would have no a priori information that App A is more efficient to run on big core. Therefore both App A and B would be scheduled more or less equally on the two cores.

However, over time the IPC measurements for both cores would become available. Now App A would increasingly run on the big core (where it benefits from much higher IPC), whereas App B scheduling would not change much (more similar IPC on both). Thus using an embodiment a change in scheduling behavior over time can be observed. And a scheduler may schedule a new application lacking performance monitoring information based on the type of application, using performance monitoring information of a similar type application (e.g., common ISA, accelerator usage or so forth).

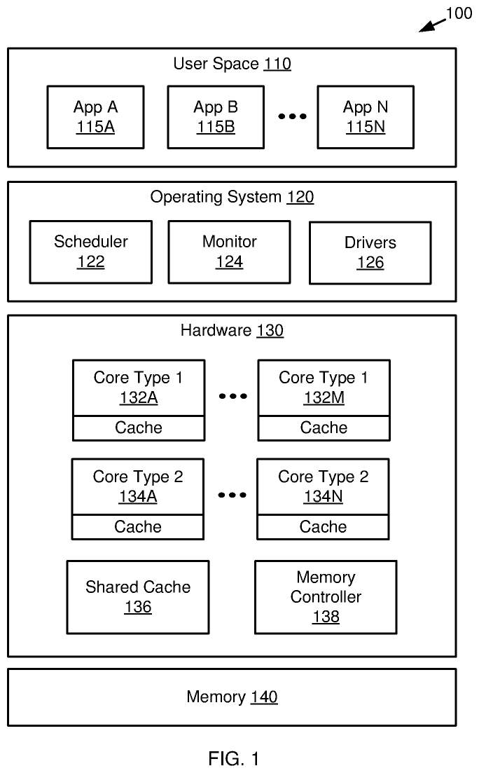

Referring now to FIG. 1, a system 100 may include a user space 110, an operating system (OS) 120, system hardware 130, and memory 140. As shown, the user space 110 any include any number of applications A-N 115A-115N (also referred to herein as “applications 115”). In some examples, the applications 115 and the OS 120 may execute on the system hardware 130. The system hardware 130 may include a plurality of heterogenous cores, such as any number of core type 1 (CT1) units 132A-132N (also referred to herein as “CT1 units 132” or “CT1 cores 132”) and any number of core type 2 (CT2) units 134A-134N (also referred to herein as “CT2 units 134” or “CT2 cores 134”). In some examples, each CT1 unit 132 could be a relatively higher performance core, while each CT2 unit 134 could be a relatively higher power efficient core.

In some embodiments, the system hardware 130 may include a shared cache 136 and a memory controller 138. The shared cache 136 may be shared by the CT1 units 132 and the CT2 units 134. Further, the memory controller 138 may control data transfer to and from memory 140 (e.g., external memory, system memory, DRAM, etc.).

In some embodiments, the OS 120 may implement a scheduler 122, a monitor 124, and drivers 126. The scheduler 122 may determine which application (“app”) 115 to run on which core 132, 134. The scheduler 122 could make the decision based on the system load, thermal headroom, power headroom, etc.

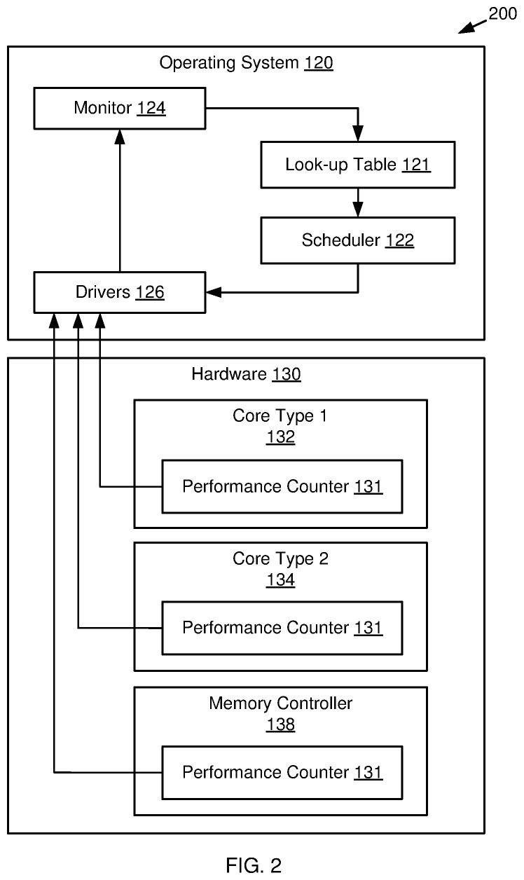

In some embodiments, each application 115 may be associated with a unique ID, which is known to the scheduler 122 when the application 115 is launched. Some embodiments may maintain additional data specific for each application 115, in order to help the scheduler 122 make better scheduling decisions. To this end, the monitor 124 may be an entity that performs a data collection to continuously collect performance information for each application 115. An example implementation of a data collection operation performed by the monitor 124 is described below with reference to FIG. 2

Referring now to FIG. 2, shown is an illustration of example data collection operation 200, in accordance with some embodiments. As shown, the monitor 124 may use a layer of drivers 126 in the OS 120 (or a kernel) to access counter values from any number of hardware performance counters 131 included in one or more of the CT1 units 132, the CT2 units 134, the memory controller 138, and any other component(s).

In one or more embodiments, the monitor 124 may compare the counter values to a look-up table 121, which includes data entries that associate an application-specific ID with performance metrics that were previously collected (e.g., historical performance metrics). Each time a particular application (e.g., application A shown in FIG. 1) is launched, the same ID is used. Accordingly, the performance metrics can be collected for each application based on the ID, and can be stored for future use and access using the ID.

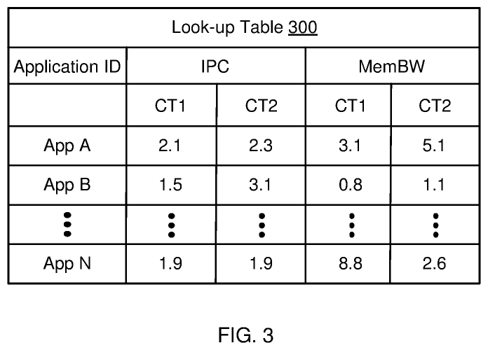

Referring now to FIG. 3, shown is an illustration of an example look-up table 300, in accordance with some embodiments. The look-up table 300 may correspond generally to an example embodiment of the implementation of the look-up table 121 (shown in FIG. 2).

As shown in FIG. 3, the performance metrics of the look-up table 300 may include information such as instructions per cycle (IPC), instructions retired/cycles, memory bandwidth used (memBW), and so forth. For each application, all the metric data may be collected per core type (CT). In some embodiments, the look-up table 300 may be built up over time including more and more entries corresponding to different application ID. Further, if the size of the look-up table 300 exceeds a predefined maximum level, the oldest entries may be dropped to allow new entries to be added to the look-up table 300.

In some embodiments, in each entry of the look-up table 300, the metric data may be averaged/filtered to smooth out short-term variations. In addition to application-specific metrics, the monitor 124 (shown in FIG. 2) may also collect overall system data, or example system load, thermal headroom, power headroom, etc.

Note that the look-up table 300 shown in FIG. 3 is an example embodiment, and is not intended to limit other embodiments. For example, it is contemplated that in various embodiments, the entries of the look-up table 300 could include additional or fewer fields (e.g., timestamp information, etc.). Additional examples of data metrics to collect and how to use them in the scheduling decision is shown in Table 1 below. Note that there may be dependencies on what other applications are running in the system. For example, if a given core is highly loaded, the IPC may differ from a lightly loaded system. This could be compensated for by considering overall system parameters (total CPU load, total memory bandwidth, etc.) and applying a correction factor to the metric.

TABLE 1

| Metric | Scope | Role in scheduling decision |
|---|---|---|
| Instructions per | Application | Applications which significantly |
| cycle (IPC) | and core | benefit from using core-specific |
| | specific | accelerators resulting in higher |
| | | IPC, should be scheduled those cores |
| Memory | Application | Applications with significant |
| Bandwidth | and core | memory BW should be scheduled on |
| | specific | cores using lower memory BW (shared |
| | | system resource) |
| Memory | Application | Applications with lower latency |
| Latency | and core | can be scheduled on more efficient |
| | specific | cores |
| Cache | Application | Applications with higher cache |
| Bandwidth | and core | bandwidth may run more efficiently |
| (BW) | specific | on core with larger caches. |
| Appliation CPU | Application | Applications which are less |
| utilization | specific | “bursty” (less variations in |
| burstiness | | CPU load) can be scheduled on lower |
| | | performance/more power-efficient |
| | | cores since their max required |
| | | processing is more predictable. |
| Runtime length | Application | Applications running short time |
| | specific | could be scheduled on a higher |
| | | performance core since they will |
| | | not run for long. |

Referring again to FIG. 2, the scheduler 122 may use the data from the look-up table 121 to dynamically decide which core type is most favorable for scheduling a given application under given system loading and constraints. In some embodiments, the scheduler 122 may also consider metrics defining overall system constraints (power, thermal, CPU load), as shown in Table 2.

TABLE 2

| Metric | Scope | Role in scheduling decision |
|---|---|---|
| Core CPU | Per core | Higher value raises threshold for |
| utilization | | scheduling on high performance core |
| Core | Per core | Higher value raises threshold for |
| Temperature | | scheduling on that specific core |
| System power | Overall | Higher value raises threshold for |
| | system | scheduling on high performance core |
| System | Overall | Higher value raises threshold for |
| Temperature | system | scheduling on high performance core |
| | | which has higher thermal impact for |
| | | the same workload |
| Graphics and | Overall | If a specific application has high |
| other shared | system | shared resource utilization (e.g. |
| resource | | Graphics), it may be preferred to |
| utilization | | schedule on a lower performance |
| | | core to keep power/thermal |
| | | footprint low. |

Note that the most efficient core for a given workload may change over time. For example, a workload may only need to use hardware accelerators at certain times, or may only be memory intensive at certain times. The monitor 124 (or other statistics collection entity) may identify such different time-phases in the workload. Using this information, the scheduler 122 may determine to move a given workload between cores over time (using thread-migration).

In an embodiment, a machine learning approach may be used to train a predictor for system performance. In this way, the actual performance and power/thermal impact (e.g., increase in CPU utilization, power or temperature) of scheduling the application on a given core type may be estimated using machine learning (ML). For example, a Neural Network (NN) may be used to estimate impact of scheduling an application on a given core type. The NN may continuously be trained using all the per-application specific data along with overall system parameters (e.g., power, temperature, graphics usage). Over time, internal weights of the NN may be adjusted (e.g., per application) so that it can accurately predict (e.g., perform inference) impact on overall system (e.g., power, temperature, system load, etc.) when scheduling a given application on the different core types.

For example, the predictor may dynamically control weights applied to the metrics shown in Table 2 based on machine learning, to make better scheduling decisions over time. This information may then be used to make a scheduling decision, by choosing the scheduling combination that achieves the best power, performance and thermal workpoint given the system constraints. Note that the NN may be retrained (e.g., by adjusting weights) periodically/continuously to account for new apps being installed on the system over time.

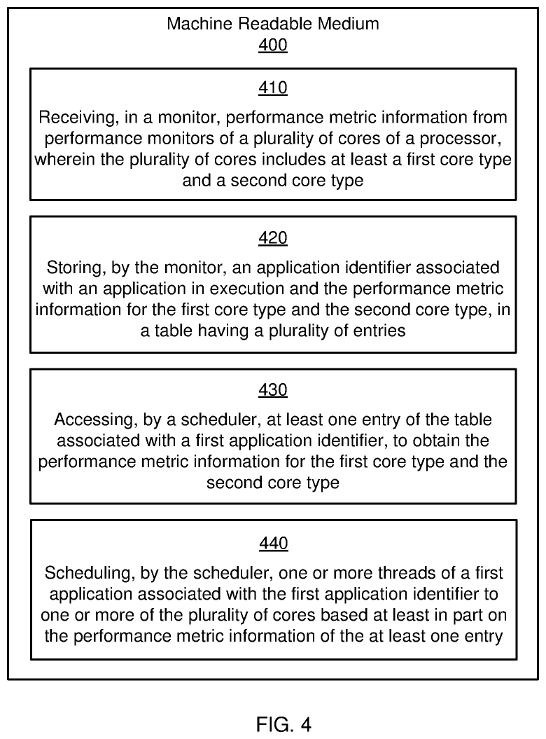

Referring now to FIG. 4, shown is a machine-readable medium 400 storing instructions 410-440, in accordance with some implementations. The instructions 410-440 can be executed by a single processor, multiple processors, a single processing engine, multiple processing engines, and so forth. The machine-readable medium 400 may be a non-transitory storage medium, such as an optical, semiconductor, or magnetic storage medium.

Instruction 410 may be executed to perform receiving, in a monitor, performance metric information from performance monitors of a plurality of cores of a processor, wherein the plurality of cores includes at least a first core type and a second core type.

Instruction 420 may be executed to perform storing, by the monitor, an application identifier associated with an application in execution and the performance metric information for the first core type and the second core type, in a table having a plurality of entries.

Instruction 430 may be executed to perform accessing, by a scheduler, at least one entry of the table associated with a first application identifier, to obtain the performance metric information for the first core type and the second core type.

Instruction 440 may be executed to perform scheduling, by the scheduler, one or more threads of a first application associated with the first application identifier to one or more of the plurality of cores based at least in part on the performance metric information of the at least one entry.

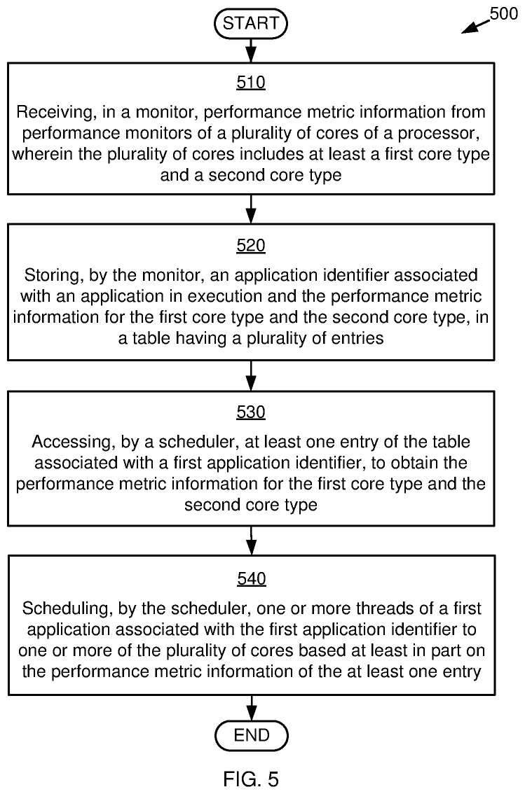

FIG. 5 shows an example process 500, in accordance with some implementations. In some examples, the process 500 may be performed by the system 100 (shown in FIG. 1). The process 500 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth.

Block 510 may include receiving, in a monitor, performance metric information from performance monitors of a plurality of cores of a processor, wherein the plurality of cores includes at least a first core type and a second core type.

Block 520 may include storing, by the monitor, an application identifier associated with an application in execution and the performance metric information for the first core type and the second core type, in a table having a plurality of entries.

Block 530 may include accessing, by a scheduler, at least one entry of the table associated with a first application identifier, to obtain the performance metric information for the first core type and the second core type.

Block 540 may include scheduling, by the scheduler, one or more threads of a first application associated with the first application identifier to one or more of the plurality of cores based at least in part on the performance metric information of the at least one entry.

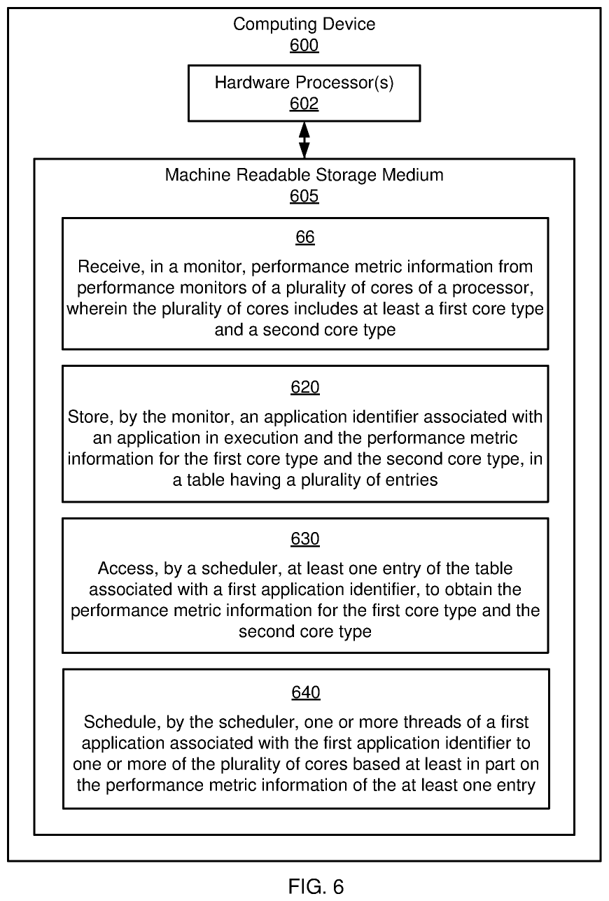

FIG. 6 shows a schematic diagram of an example computing device 600. In some examples, the computing device 600 may correspond generally to some or all of the system 100 (shown in FIG. 1). As shown, the computing device 600 may include hardware processor 602 and machine-readable storage 605 including instructions 610-640. The machine-readable storage 605 may be a non-transitory medium. The instructions 610-640 may be executed by the hardware processor 602, or by a core or other processing engine included in hardware processor 602.

Instruction 610 may be executed to receive, in a monitor, performance metric information from performance monitors of a plurality of cores of a processor, wherein the plurality of cores includes at least a first core type and a second core type.

Instruction 620 may be executed to store, by the monitor, an application identifier associated with an application in execution and the performance metric information for the first core type and the second core type, in a table having a plurality of entries.

Instruction 630 may be executed to access, by a scheduler, at least one entry of the table associated with a first application identifier, to obtain the performance metric information for the first core type and the second core type.

Instruction 640 may be executed to schedule, by the scheduler, one or more threads of a first application associated with the first application identifier to one or more of the plurality of cores based at least in part on the performance metric information of the at least one entry.

The following clauses and/or examples pertain to further embodiments.

In Example 1, at least one computer readable storage medium has stored thereon instructions, which if performed by a system cause the system to perform a method for thread scheduling. The method may include: receiving, in a monitor, performance metric information from performance monitors of a plurality of cores of a processor, wherein the plurality of cores includes at least a first core type and a second core type; storing, by the monitor, an application identifier associated with an application in execution and the performance metric information for the first core type and the second core type, in a table having a plurality of entries; accessing, by a scheduler, at least one entry of the table associated with a first application identifier, to obtain the performance metric information for the first core type and the second core type; and scheduling, by the scheduler, one or more threads of a first application associated with the first application identifier to one or more of the plurality of cores based at least in part on the performance metric information of the at least one entry.

In Example 2, the subject matter of Example 1 may optionally include scheduling one or more threads further based on a load of the system.

In Example 3, the subject matter of Examples 1-2 may optionally include that the performance metric information comprises one or more of instructions per cycle and memory bandwidth.

In Example 4, the subject matter of Examples 1-3 may optionally include scheduling, by the scheduler, the first application to the first core type, the first application having a greater instructions per cycle on the first core type than on the second core type.

In Example 5, the subject matter of Examples 1-4 may optionally include adjusting, based on machine learning, weighting of at least some of the performance metric information of the at least entry or one or more system metric values when scheduling the one or more threads of the first application.

In Example 6, the subject matter of Examples 1-5 may optionally include that the first core type has relatively higher performance than the second core type.

In Example 7, the subject matter of Examples 1-6 may optionally include that the second core type has relatively higher power efficiency than the first core type.

In Example 8, a computing device for thread scheduling may include a processor and a machine-readable storage medium that stores instructions. The instructions may be executable by the hardware processor to: receive, in a monitor, performance metric information from performance monitors of a plurality of cores of a processor, wherein the plurality of cores includes at least a first core type and a second core type; store, by the monitor, an application identifier associated with an application in execution and the performance metric information for the first core type and the second core type, in a table having a plurality of entries; access, by a scheduler, at least one entry of the table associated with a first application identifier, to obtain the performance metric information for the first core type and the second core type; and schedule, by the scheduler, one or more threads of a first application associated with the first application identifier to one or more of the plurality of cores based at least in part on the performance metric information of the at least one entry.

In Example 9, the subject matter of Example 8 may optionally include instructions to schedule one or more threads further based on a load of the system.

In Example 10, the subject matter of Examples 8-9 may optionally include that the performance metric information comprises one or more of instructions per cycle and memory bandwidth.

In Example 11, the subject matter of Examples 8-10 may optionally include instructions to schedule, by the scheduler, the first application to the first core type, the first application having a greater instructions per cycle on the first core type than on the second core type.

In Example 12, the subject matter of Examples 8-11 may optionally include instructions to adjust, based on machine learning, weighting of at least some of the performance metric information of the at least entry or one or more system metric values when scheduling the one or more threads of the first application.

In Example 13, the subject matter of Examples 8-12 may optionally include that the first core type has relatively higher performance than the second core type.

In Example 14, the subject matter of Examples 8-13 may optionally include that the second core type has relatively higher power efficiency than the first core type.

In Example 15, a method for thread scheduling may include: receiving, in a monitor, performance metric information from performance monitors of a plurality of cores of a processor, wherein the plurality of cores includes at least a first core type and a second core type; storing, by the monitor, an application identifier associated with an application in execution and the performance metric information for the first core type and the second core type, in a table having a plurality of entries; accessing, by a scheduler, at least one entry of the table associated with a first application identifier, to obtain the performance metric information for the first core type and the second core type; and scheduling, by the scheduler, one or more threads of a first application associated with the first application identifier to one or more of the plurality of cores based at least in part on the performance metric information of the at least one entry.

In Example 16, the subject matter of Example 15 may optionally include scheduling one or more threads further based on a load of the system.

In Example 17, the subject matter of Examples 15-16 may optionally include that the performance metric information comprises one or more of instructions per cycle and memory bandwidth.

In Example 18, the subject matter of Examples 15-17 may optionally include scheduling, by the scheduler, the first application to the first core type, the first application having a greater instructions per cycle on the first core type than on the second core type.

In Example 19, the subject matter of Examples 15-18 may optionally include adjusting, based on machine learning, weighting of at least some of the performance metric information of the at least entry or one or more system metric values when scheduling the one or more threads of the first application.

In Example 20, the subject matter of Examples 15-19 may optionally include that the first core type has relatively higher performance than the second core type, and that the second core type has relatively higher power efficiency than the first core type.

In Example 21, an apparatus for thread scheduling may include: means for receiving, in a monitor, performance metric information from performance monitors of a plurality of cores of a processor, wherein the plurality of cores includes at least a first core type and a second core type; means for storing, by the monitor, an application identifier associated with an application in execution and the performance metric information for the first core type and the second core type, in a table having a plurality of entries; means for accessing, by a scheduler, at least one entry of the table associated with a first application identifier, to obtain the performance metric information for the first core type and the second core type; and means for scheduling, by the scheduler, one or more threads of a first application associated with the first application identifier to one or more of the plurality of cores based at least in part on the performance metric information of the at least one entry.

In Example 22, the subject matter of Example 21 may optionally include means for scheduling one or more threads further based on a load of the system.

In Example 23, the subject matter of Examples 21-22 may optionally include that the performance metric information comprises one or more of instructions per cycle and memory bandwidth.

In Example 24, the subject matter of Examples 21-23 may optionally include means for scheduling, by the scheduler, the first application to the first core type, the first application having a greater instructions per cycle on the first core type than on the second core type.

In Example 25, the subject matter of Examples 21-24 may optionally include means for adjusting, based on machine learning, weighting of at least some of the performance metric information of the at least entry or one or more system metric values when scheduling the one or more threads of the first application.

In Example 26, the subject matter of Examples 21-25 may optionally include that the first core type has relatively higher performance than the second core type, and that the second core type has relatively higher power efficiency than the first core type.

Note that the terms “circuit” and “circuitry” are used interchangeably herein. As used herein, these terms and the term “logic” are used to refer to alone or in any combination, analog circuitry, digital circuitry, hard wired circuitry, programmable circuitry, processor circuitry, microcontroller circuitry, hardware logic circuitry, state machine circuitry and/or any other type of physical hardware component. Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SoC or other processor, is to configure the SoC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. At least one computer readable storage medium having stored thereon instructions, which if performed by a system cause the system to perform a method comprising:
receiving, in a monitor, performance metric information from performance monitors of a plurality of cores of a processor, wherein the plurality of cores includes at least a first core type and a second core type;
storing, by the monitor, an application identifier associated with an application in execution and the performance metric information for the first core type and the second core type, in a table having a plurality of entries;
accessing, by a scheduler, at least one entry of the table associated with a first application identifier, to obtain the performance metric information for the first core type and the second core type; and
scheduling, by the scheduler, one or more threads of a first application associated with the first application identifier to one or more of the plurality of cores based at least in part on the performance metric information of the at least one entry.

2. The computer readable storage medium of claim 1, wherein the method further comprises scheduling one or more threads further based on a load of the system.

3. The computer readable storage medium of claim 1, wherein the performance metric information comprises one or more of instructions per cycle and memory bandwidth.

4. The computer readable storage medium of claim 1, wherein the method further comprises scheduling, by the scheduler, the first application to the first core type, the first application having a greater instructions per cycle on the first core type than on the second core type.

5. The computer-readable storage medium of claim 1, wherein the method further comprises adjusting, based on machine learning, weighting of at least some of the performance metric information of the at least entry or one or more system metric values when scheduling the one or more threads of the first application.

6. The computer-readable storage medium of claim 1, wherein the first core type has relatively higher performance than the second core type.

7. The computer-readable storage medium of claim 6, wherein the second core type has relatively higher power efficiency than the first core type.

8. A computing device comprising:
a processor; and
a machine-readable storage medium storing instructions, the instructions executable by the hardware processor to:
receive, in a monitor, performance metric information from performance monitors of a plurality of cores of a processor, wherein the plurality of cores includes at least a first core type and a second core type;
store, by the monitor, an application identifier associated with an application in execution and the performance metric information for the first core type and the second core type, in a table having a plurality of entries;
access, by a scheduler, at least one entry of the table associated with a first application identifier, to obtain the performance metric information for the first core type and the second core type; and
schedule, by the scheduler, one or more threads of a first application associated with the first application identifier to one or more of the plurality of cores based at least in part on the performance metric information of the at least one entry.

9. The computing device of claim 8, including instructions to schedule one or more threads further based on a load of the system.

10. The computing device of claim 8, wherein the performance metric information comprises one or more of instructions per cycle and memory bandwidth.

11. The computing device of claim 8, including instructions to schedule, by the scheduler, the first application to the first core type, the first application having a greater instructions per cycle on the first core type than on the second core type.

12. The computing device of claim 8, including instructions to adjust, based on machine learning, weighting of at least some of the performance metric information of the at least entry or one or more system metric values when scheduling the one or more threads of the first application.

13. The computing device of claim 8, wherein the first core type has relatively higher performance than the second core type.

14. The computing device of claim 13, wherein the second core type has relatively higher power efficiency than the first core type.

15. A method comprising:
receiving, in a monitor, performance metric information from performance monitors of a plurality of cores of a processor, wherein the plurality of cores includes at least a first core type and a second core type;
storing, by the monitor, an application identifier associated with an application in execution and the performance metric information for the first core type and the second core type, in a table having a plurality of entries;
accessing, by a scheduler, at least one entry of the table associated with a first application identifier, to obtain the performance metric information for the first core type and the second core type; and
scheduling, by the scheduler, one or more threads of a first application associated with the first application identifier to one or more of the plurality of cores based at least in part on the performance metric information of the at least one entry.

16. The method of claim 15, including scheduling one or more threads further based on a load of the system.

17. The method of claim 15, wherein the performance metric information comprises one or more of instructions per cycle and memory bandwidth.

18. The method of claim 15, including scheduling, by the scheduler, the first application to the first core type, the first application having a greater instructions per cycle on the first core type than on the second core type.

19. The method of claim 15, including adjusting, based on machine learning, weighting of at least some of the performance metric information of the at least entry or one or more system metric values when scheduling the one or more threads of the first application.

20. The method of claim 15, wherein the first core type has relatively higher performance than the second core type, and wherein the second core type has relatively higher power efficiency than the first core type.
